(19) United States
(12) Patent Application Publication
(10) Pub. No.: US 2023/0259075 A1
(43) Pub. Date: Aug. 17, 2023

(54) DYNAMIC MULTI-OBJECTIVE PARTICLE SWARM OPTIMIZATION-BASED OPTIMAL CONTROL METHOD FOR WASTEWATER TREATMENT PROCESS

(71) Applicant: BEIJING UNIVERSITY OF TECHNOLOGY, Beijing (CN)

(72) Inventors: Honggui HAN, BEIJING (CN); Lu ZHANG, BEIJING (CN); Junfei QIAO, BEIJING (CN)

(21) Appl. No.: 18/136,812

(22) Filed: Apr. 19, 2023

Related U.S. Application Data
(63) Continuation-in-part of application No. 16/696,967, filed on Nov. 26, 2019, now abandoned.

(30) Foreign Application Priority Data
Jun. 10, 2019 (CN) 201910495404.5

(51) Int. Cl. G05B 13/02; C02F 3/30; G05B 13/04

(52) U.S. Cl. CPC G05B 13/0265; C02F 3/302; G05B 13/041

(57) ABSTRACT

A dynamic multi-objective particle swarm optimization based optimal control method is provided to realize the control of dissolved oxygen (S_{O}) and the nitrate nitrogen (S_{NO}) in wastewater treatment process. In this method, dynamic multi-objective particle swarm optimization was used to optimize the operation objectives of WWTP, and the optimal solutions of S_{O} and S_{NO} can be calculated. Then PID controller was introduced to trace the dynamic optimal solutions of S_{O} and S_{NO}. The results demonstrated that the proposed optimal control strategy can address the dynamic optimal control problem, and guarantee the efficient and stable operation. In addition, this proposed optimal control method in this present invention can guarantee the effluent qualities and reduce the energy consumption.

### CROSS REFERENCE TO RELATED PATENT APPLICATIONS

This application is a continuation-in-part of U.S. application Ser. No. 16/696,967, filed on Nov. 26, 2019, which in turn claims priority to Chinese Patent Application No. 201910495404.5, filed on Jun. 10, 2019, entitled “Dynamic multi-objective particle swarm optimization-based optimal control method for wastewater treatment process,”. The contents of the above identified applications are hereby incorporated by reference in its entirety.

### TECHNICAL FIELD

In this present invention, a dynamic multi-objective particle swarm optimization (DMPSO) algorithm is used to solve the optimization objectives in wastewater treatment process (WWTP), and then the optimal solutions of dissolved oxygen (S_{O}) and nitrate nitrogen (S_{NO}) can be obtained. Both S_{O} and S_{NO} have an important influence on the energy consumption and effluent quality of WWTP, and determine the treatment effect of WWTP. It is necessary to design DMOPSO-based optimal control method to control S_{O} and S_{NO} for WWTP, which can guarantee the effluent qualities and reduce the energy consumption.

### BACKGROUND

WWTP refers to the physical, chemical and biological purification process of wastewater, so as to meet the requirements of discharge or reuse. Currently, natural freshwater resources have been fully exploited and natural disasters are increasingly occurred. Water shortage has posed a very serious threat to the economy and citizens' lives of many cities around the world. Water shortage crisis has been the reality we are facing. An important way to solve this problem is to turn the municipal wastewater into water supply source. Municipal wastewater is available in the vicinity, with the features of stable sources and easy collection. Stable and efficient wastewater treatment system is the key to the recycling of water resources, which has good environmental and social benefits. Therefore, the research results of the present invention have broad application prospects.

WWTP is a complex dynamic system. Its biochemical reaction cycle is long and pollutant composition is complex. Influent flow rate and influent qualities are passively accepted. The primary performance indices, such as pumping energy (PE), aeration energy (AE) and effluent quality (EQ), are strongly nonlinear and coupling. The essence of improving the treatment effect of WWTP is a dynamic multi-objective optimal control problem. It is significant to establish appropriate optimization objectives based to the dynamic operation characteristics of WWTP. Since the optimization objectives of WWTP are interactional, how to balance the relationship of the optimization objectives is of great significance to ensure the quality of effluent organisms and reduce energy consumption. In addition, S_{O} and S_{NO}, as the main controlled variables, have great influence on the operation efficiency and the operation performance. Therefore, it is necessary to establish a dynamic optimal control method, which can establish the optimization objectives and realize the tracking control according to the different operation conditions and the dynamic operation environments. The dynamic optimal control method can efficiently guarantee the effluent organisms in the limits and reduce the operation cost as much as possible.

In this present invention, a DMOPSO-based optimal control method is designed for WWTP, where the models of the performance indices can be established based on the dynamics and the operation data of WWTP. DMOPSO algorithm is designed to optimize the established optimization objectives and derive the optimal solutions of S_{O} and S_{NO}. Then multivariable PID controller is introduced to trace the optimal solutions S_{O} and S_{NO}.

### SUMMARY

In this present invention, a dynamic multi-objective particle swarm optimization-based optimal control method and system for WWTP is designed, where hardware facilities and software modules are included.

The hardware facilities include data acquisition devices (flow meter, dissolved oxygen detector, nitrate nitrogen detector, ammonia nitrogen detector, suspended solids concentration detector, effluent biochemical oxygen demand detector, effluent chemical oxygen demand detector, effluent ammonia nitrogen detector, effluent total nitrogen detector, effluent suspended solids concentration), control devices (aeration pump, reflow pump), data transmission devices (communication interface, remote interface) and programmable logic controller PLC.

As the controlled object, WWTP mainly includes biochemical reaction process and sedimentation process, among them, the biochemical reaction process is divided into five tanks, including an anaerobic tank, an anoxic tank and three aerobic tanks, mainly involving three reaction processes. Firstly, wastewater enters an anaerobic tank from a water inlet for reaction of ammonization. Secondly, the wastewater enters an anoxic tank from the anaerobic tank for denitrification reaction. Finally, the wastewater flows from the anoxic tank to the three aerobic tanks for nitrification reaction, and flows into the secondary sedimentation tank for sedimentation. The anaerobic tank and the anoxic tank are respectively provided with a stirrer to fully mix the activated sludge and the wastewater. The aeration pump arranged at the third aerobic tank can charge oxygen for the three aerobic tanks, and the reflow pump arranged between the third aerobic tank and the anaerobic tank is used for controlling the reflow rate of the internal circulation. The treated wastewater enters a secondary sedimentation tank to realize the separation of activated sludge and effluent. Then the effluent is discharged from the upper end of the secondary sedimentation tank, part of the activated sludge is discharged from the bottom end of the secondary sedimentation tank, and the remaining sludge is returned to the anaerobic tank by the control action of the reflow pump arranged at the secondary sedimentation tank. Data acquisition sensors are arranged in the anaerobic tank, the anoxic tank, the aerobic tank and the secondary sedimentation tank.

The data acquisition device installed in the biochemical reaction process comprises:

A flow meter arranged in the anaerobic tank and used for acquiring inflow flow data, a portable dissolved oxygen detector installed in the third aerobic tank for obtaining dissolved oxygen concentration data, a nitrate nitrogen detector arranged in the anoxic tank and used for acquiring nitrate nitrogen concentration data, an ammonia nitrogen detector arranged in the third aerobic tank and used for acquiring ammonia nitrogen data, a suspended matter concentration detector installed in the anoxic tank for acquiring suspended matter concentration data.

The data acquisition device installed in the secondary sedimentation tank:

An effluent ammonia nitrogen detector for acquiring effluent ammonia nitrogen data, an effluent total nitrogen detector for acquiring effluent total nitrogen data, an effluent suspended matter concentration detector for acquiring effluent suspended matter data, an effluent biochemical oxygen demand detector for obtaining effluent biochemical oxygen demand data, a water outlet chemical oxygen demand detector used for acquiring water outlet chemical oxygen demand data.

The data transmission end of each instrument in the wastewater treatment process is connected to the computer by using the communication interface and the remote interface in the data transmission device. The programmable logic controller PLC is used for changing the rotating speed of the driving motor of the aeration pump and the reflow pump to control the output of the aeration pump and the reflow pump.

The software module includes data acquisition module, intelligent modeling module, multi-objective optimization module and control module.

The data acquisition module is used for acquiring data information such as process variables related to the wastewater treatment process and optimized operation performance indexes.

The intelligent modeling module is used for establishing an optimal operation performance index model of the wastewater treatment process, and comprises a pumping energy consumption model, an aeration energy consumption model and an effluent quality model.

The multi-objective optimization module is used for simultaneously optimizing a plurality of performance indexes of the wastewater treatment process, including pumping energy, aeration energy and effluent water quality, and obtaining optimal values of related control variables.

The control module compares the control action of the aeration pump and the reflow pump with the obtained optimized set value of the control variable, so as to carry out the control action.

The invention relates to a dynamic multi-objective particle swarm optimization-based optimal control method for WWTP, which comprises the following steps:

Step 1: acquiring each performance index parameters of WWTP through data acquisition sensors, and transmitting the performance index values and the related process variable values thereof to a data acquisition module. The performance indexes mainly include pumping energy (PE), aeration energy (AE) and effluent quality (EQ).

PE mainly refers to the power consumption generated by the internal reflow pump, which is measured by the pumping energy power meter. AE mainly refers to the power consumption generated by aeration pump during aeration, which is measured by aeration energy power meter. EQ mainly refers to the tax or penalty to be paid for discharging pollution to the receiving water body. The pollutants mainly include effluent ammonia nitrogen (S_{NH,e}), effluent total nitrogen (N_{tot,e}), effluent suspended solids (SSₑ), effluent biochemical oxygen demand (BODₑ), effluent chemical oxygen demand (CODₑ) obtained by the data acquisition devices installed in the secondary sedimentation tank.

Step 2: transmit the performance index values and the related process variable values thereof to an intelligent modeling module through a data transmission protocol, and the intelligent modeling module establish a performance index model of the wastewater treatment system according to the related process variables of the performance index obtained by the data acquisition module.

The wastewater treatment system performance index model comprises PE model, AE model and EQ model. With the progress of wastewater treatment operation, the collected data is also constantly updated, and performance index models in the intelligent modeling module will be updated and adjusted along with the change of the collected data. The steps for constructing a performance indicator model for sewage treatment process include:

\textcircled{1} obtain the operating data of the performance indices and the related process variables. The performance indices mainly contain PE, AE and EQ. The related process variables of PE, AE and EQ contain influent flow rate (Qᵢₙ), dissolved oxygen (S_{O}), nitrate nitrogen (S_{NO}), ammonia nitrogen (S_{NH}), suspended solids (SS), which can be measured by the corresponding sensors.

\textcircled{2} establish the nonlinear models of PE, AE, EQ and the related process variables. Since the adjusting time of the two controlled variables S_{O} and S_{NO} are different, the established models of PE, AE and EQ also have different adjusting periods. Because S_{O} has great influence on AE and EQ, the nonlinear models of AE and EQ will be adjusted every thirty minutes, which is the same as the adjusting period of S_{O}. In addition, S_{NO} has great influence on PE, so the model of PE will be adjusted every two hours, which is the same as the adjusting period of S_{NO}. Two sets of objectives are established

$$\begin{matrix}\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t )\end{matrix} & ( 1 ) \\ \{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t ) \\ {f}_{3} ( t ) = {\sum }_{r = 1}^{10} {W}_{3 r} ( t ) \times {e}^{- {‖ s ( t ) - {c}_{3 r} ( t ) ‖}^{2} / 2 {{b}_{3 r} ( t )}^{2}} + {W}_{3} ( t )\end{matrix} & ( 2 )\end{matrix}$$

where f₁(t) is AE model at the tth time, f₂(t) is EQ model at the tth time, f₃(t) is PE model at the tth time, x(t)=[Qᵢₙ(t), S_{O}(t)] is the inputs of AE model, l(t)=[Qᵢₙ(t), S_{O}(t), S_{NO}(t), S_{NH}(t), SS(t)] is the inputs of EQ model, s(t)=[Qᵢₙ(t), S_{NO}(t), SS(t)] is the inputs of PE model,

$${e}^{- {‖ x ( t ) - {c}_{1 r} ( t ) ‖}^{2} / 2 {{b}_{1 r} ( t )}^{2}} , {e}^{- {‖ l ( t ) - {c}_{2 r} ( t ) ‖}^{2} / 2 {{b}_{2 r} ( t )}^{2}} and {e}^{- {‖ s ( t ) - {c}_{3 r} ( t ) ‖}^{2} / 2 {{b}_{3 r} ( t )}^{2}}$$

are the rth radial basis functions of f₁(t),f₂(t) and f₃(t) at the tth time, r=1, 2, . . . , 10, c₁ᵣ(t), c₂ᵣ(t) and c₃ᵣ(t) are the center vectors of the rth radial basis functions of f₁(t), f₂(t) and f₃(t) at the tth time, and the ranges of c₁ᵣ(t), c₂ᵣ(t) and c₃ᵣ(t) are [−1, 1] respectively; b₁ᵣ(t), b₂ᵣ(t) and b₃ᵣ(t) are the width vectors of the rth radial basis functions of f₁(t), f₂(t) and f₃(t) at the tth time, whose ranges are (0, 2] respectively, W₁ᵣ(t), W₂ᵣ(t) and W₃ᵣ(t) are the weight vectors of the rth radial basis functions of f₁(t) and f₂(t) at the tth time, whose ranges are [−3, 3] respectively; W₁(t), W₂(t) and W₃(t) are the biases of the rth radial basis functions of f₁(t) and f₂(t) at the tth time, whose ranges are [−2, 2] respectively. When every two hours is reached, Eq. (2) is taken as the operating objectives, otherwise, Eq. (1) is regarded as the operating objectives.

Step 3: transmitting model results of the PE model, AE model and EQ model built in the intelligent modeling module to the multi-objective optimization module. In the multi-objective optimization module, the constructed PE model, AE model and EQ model are taken as optimization objectives, and then the optimization objectives are optimized by using the designed dynamic multi-objective particle swarm optimization algorithm to obtain the optimized set values of the control variables S_{O} and S_{NO}.

Since the optimal set values of S_{O} and S_{NO} change in real time with the progress of wastewater treatment operation process, the optimal set values of S_{O} and S_{NO} concentration are recalculated every two hours. The updated optimized set points for dissolved oxygen and nitrate concentration are transmitted to the control module in real time.

In WWTP, S_{O} and S_{NO} are two important controlled variables to guarantee the treatment results and improve the operating performance. Due to the changes of passively accepted influent flow rate, fixed set-points of S_{O} and S_{NO} are not beneficial for reducing the PE, AE and EQ. Therefore, a dynamic optimization algorithm is designed for calculating the time-varying set-points of S_{O} and S_{NO}. The steps of the dynamic optimization process include:

(3)-1 set the maximum iterative numbers of the optimization process Tₘₐₓ;

(3)-2 take the established models of performance indices in Eq. (1) and (2) as the optimization objectives;

s (3)-3 regard all the related inputs of PE, AE and EQ as the position of the particles, a(t)=[Qᵢₙ(t), S_{O}(t), S_{NO}(t), S_{NH}(t), SS(t)], calculate values of the optimization objectives, update the personal optimal position (pBest_{k,i}(t)) and the position and the velocity of the particles, the update process are:

a_{k,i}(t+1)=a_{k,i}(t)+v_{k,i}(t+1) (3)

v_{k,i}(t+1)=ω(t)v_{k,i}(t)+c₁α₁(pBest_{k,i}(t)−x_{k,i}(t))+c₂α₂(gBestₖ(t)−x_{k,i}(t)) (4)

where a_{k,i}(t+1) is the position of the ith particle in the kth iteration at the t+1 th time, v_{k,i}(t+1) is the velocity of the ith particle in the kth iteration at the t+1th time, ω is the inertia weight, the range of ω is (0, 1], c₁ and c₂ are the learning parameters, α₁ and α₂ are the uniformly distributed random numbers, pBest_{k,i}(t) is the personal optimal position of the ith particle in the kth iteration at the tth time, and gBestₖ(t) is the personal optimal position in the kth iteration at the tth time;

(3)-4 design the diversity index and the convergence index based on the Chebyshev distance, diversity index is designed to measure the distribution quality of the non-dominated solutions,

$$U ( t ) = \sqrt{\frac{1}{NS ( t ) - 1} {\sum }_{m = 1}^{NS ( t )} {( {D}^{⌣} ( t ) - {D}_{m} ( t ) )}^{2}} \qquad ( 5 )$$

where U(t) is the diversity of the optimal solutions at the tth time, m=1, 2, . . . , NS(t), NS(t) is the number of non-dominated solutions at time t, Ď(t) is the average distance of all the Chebyshev distance Dₘ(t), Dₘ(t) is the Chebyshev distance of consecutive solutions of the mth solution; and convergence index is developed to obtain the degree of proximity, which are calculated as

$$A ( t ) = \frac{1}{NS ( t )} \sqrt{{\sum }_{l = 1}^{NS ( t )} {d}_{l} ( t )} \qquad ( 6 )$$

where A(t) is the convergence of the optimal solutions at the tth time, dₗ(t) is the Chebyshev distance of the lth solution between the kth iteration and the k−1th iteration;

(3)-5 judge the changes of the optimization objectives, if the number of the objectives is changed, return to step (3)-6; otherwise, return to (3)-7;

(3)-6 when the number of the objectives is increased, some particles will be changed to enhance the diversity performance, the update process of the population size is

$${N}_{k + 1} = \{ \begin{matrix}{N}_{k} ( t ) & {α}_{k} ( t ) = 0 \\ {N}_{k} ( t ) - ( {N}_{k} ( t ) - {NS}_{k} ( t ) ) \cdot {α}_{k} ( t ) & {α}_{k} ( t ) < 0 \\ {N}_{k} ( t ) + {NS}_{k} ( t ) \cdot {α}_{k} ( t ) & {α}_{k} ( t ) > 0\end{matrix} \qquad ( 7 )$$

where Nₖ₊₁(t) and Nₖ(t) are the population size in the kth iteration and in the k+1th iteration at the tth time respectively, αₖ(t) is the gradient of diversity in the kth iteration at the tth time, which is calculated as

$${α}_{k} ( t ) = \frac{{U}_{k} ( t ) - {U}_{k} ( t - ε )}{ε} \qquad ( 8 )$$

where ε is the adjusted frequency of population size, and the range of ε is [1, Tₘₐₓ]; if the number of the objectives is decreased, some particles will be changed to improve the convergence performance, the update process of the population size is

$${N}_{k + 1} = \{ \begin{matrix}{N}_{k} ( t ) & {α}_{k} ( t ) = 0 \\ {N}_{k} ( t ) + {NS}_{k} ( t ) \cdot {β}_{k} ( t ) & {α}_{k} ( t ) < 0 \\ {N}_{k} ( t ) - ( {N}_{k} ( t ) - {NS}_{k} ( t ) ) \cdot {β}_{k} ( t ) & {α}_{k} ( t ) > 0\end{matrix} \qquad ( 9 )$$

where βₖ(t) is the gradient of convergence in the kth iteration at the tth time, which is calculated as

$${β}_{k} ( t ) = \frac{{A}_{k} ( t ) - {A}_{k} ( t - ε )}{ε} \qquad ( 10 )$$

(3)-7 compare pBestₖ(t) with the solutions Φₖ₋₁(t) in the archive, where Φₖ₋₁(t)=[φ_{k-1,1}(t), φ_{k-1,2}(t), . . . , φ_{k-1,l}(t)], φ_{k-1,l}(t) is the lth optimal solutions in the k−1th iteration at the tth time of the archive, the archive Φₖ(t) is updated by the dominated relationship, and the calculation process of the dominated relationship can be shown as

Φₖ(t)=Φₖ₋₁(t)∪pₖ₋₁(t), if fₕ(aₖ₋ₗ(t))≥fₕ(pₖ(t)), h=1,2,3 (11)

where ∪ is the relationship of combine, if the value of pBestₖ₋₁(t) is lower than the objective value of a_{k-1,l}(t), then the pBestₖ₋₁(t) will be saved in the archive, otherwise, a_{k-1,l}(t) will be saved, then gBestₖ(t) will be selected from the archive according to the density method;

(3)-8 if the current iteration is greater than Tₘₐₓ, then return to step (3)-9, otherwise, return to step (3)-3;

(3)-9 select a set of global optimal solutions gBest_{Tmax}(t) from the archive randomly, and gBest_{Tmax}(t)=[Q_{in,Tmax}*(t), S_{O,Tmax}*(t), S_{NO,Tmax}*(t), S_{NH,Tmax}*(t), SS_{Tmax}*(t)], where Q_{in,Tmax}*(t) the optimal solution of influent flow rate, S_{O,Tmax}*(t) is the optimal solution of dissolved oxygen, S_{NO,Tmax}*(t) is the optimal solution of nitrate nitrogen, S_{NH,Tmax}*(t) is the optimal solution of ammonia nitrogen, SS_{Tmax}*(t) is the optimal solution of suspend solid;

Step 4: transmitting the optimized set values of S_{O,Tmax}* and S_{NO,Tmax}* obtained in step 3 to a control module, changing the rotating speeds of the driving motors of the aeration pump and the reflow pump by adjusting the variable quantity of the variable frequency output of the programmable logic controller PLC, controlling the air velocity of the aeration pump and the internal circulation flow of the reflow pump, thereby controlling the concentration of S_{O} in the third aerobic tank and the concentration of S_{NO} in the anoxic tank. The control action is obtained by a multivariable PID controller, which can be shown as

$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$

where Δu(t)=[ΔK_{L}a(t), ΔQₐ(t)]^{T}, ΔK_{L}a(t) is the variation of oxygen transfer coefficient in the third aeration tank at time t, ΔQₐ(t) is the variation of internal recycle flow rate at time t, Kₚ is the proportionality coefficient, H_{τ} is the integral time constants, H_{d} is the differential time constants, e(t) is the errors between the real outputs and the optimal set-points

e(t)=z(t)−y(t) (13)

where e(t)=[e₁(t), e₂(t)]^{T}, e₁(t) and e₂(t) are the errors of S_{O} and S_{NO} respectively, z(t)=[z₁(t), z₂(t)]^{T}, z₁(t) and z₂(t) are the derived optimal set-points of S_{O} and S_{NO} at time t, y(t)[y₁(t), y₂(t)]^{T}, y₁(t) and y₂(t) are the real values of S_{O} and S_{NO} at time t.

As the optimal set-points of S_{O,Tmax}* and S_{NO,Tmax}* are changing timely, it is necessary to compare the control action of airflow rate and internal recycle flow rate with the response of S_{O} and S_{NO} concentration.

When the real concentration value of S_{O} is close to the optimized set value of the S_{O} concentration obtained in the step 3, the control quantity of the current frequency conversion output of the PLC is kept, and the rotating speed of the driving motor of the aeration pump is not changed. When the real value of S_{O} is less than the optimized set value, the variation of the current frequency conversion output of the PLC is calculated according to the control method in the control module, the rotating speed of the driving motor of the aeration pump is increased, and the aeration amount of the aeration pump is increased, so that the microbial activity is increased and the effluent quality is improved. When the real value of S_{O} is greater than the optimized set value, the variation of the current frequency conversion output of the PLC is calculated by a control method in the control module, the rotating speed of the driving motor of the aeration pump is reduced, and the aeration amount of the aeration pump is reduced, so that the aeration energy consumption is reduced.

When the real concentration value of the nitrate nitrogen is close to the optimized set value of the nitrate nitrogen concentration obtained in the step 3, the control quantity of the current variable frequency output of the PLC is kept, and the rotating speed of the driving motor of the reflow pump is not changed. When the real value of nitrate nitrogen is less than the optimized set value, the variation of the current frequency conversion output of the PLC is calculated according to the variation of the internal circulation flow, the rotating speed of the driving motor of the reflow pump is increased, and the reflow rate of the reflow pump is increased, so that the nitrogen is removed and the effluent quality is improved. When the real value of nitrate nitrogen is greater than the optimized set value, the change amount of the current variable frequency output of the PLC is calculate according to the change of the internal circulation flow, the rotating speed of the driving motor of the reflow pump is reduced, and the reflow rate of the reflow pump is reduced, so that the pumping energy consumption is reduced.

The novelties of this present disclosure contain:

(1) In this present invention, due to the difference of the adjusting time of controlled variables S_{O} and S_{NO}, the established models of performance indices PE, AE and EQ have different adjusting periods. This means the optimization of the three performance indices PE, AE and EQ is multiple time-scale. To realize the multiple time-scale optimization of PE, AE and EQ, a DMOPSO algorithm is designed for deriving the optimal solutions of controlled variables.

(2) Due to the passively accepted influent qualities as well as changing operating conditions, fixed values of controlled variables are not conductive to satisfy the effluent discharge limits and reduce the operating consumption. A DMOPSO-based optimal control strategy is proposed to optimize the multiple time-scale performance indices for deriving the time-varying optimal set-points of S_{O} and S_{NO}, and trace the time-varying set-points for guaranteeing the operating performance.

Attention: for the convenient description, multiple time-scale optimization objectives, DMOPSO algorithm and multivariable PID controller are used to realize the optimal control of WWTP. The other optimal control methods based on different multiple time-scale optimization objectives, dynamic optimization algorithm and control strategy also belong to the scope of this present invention.

### BRIEF DESCRIPTION OF THE DRAWINGS

FIG. 1 shows the hardware schematic diagram of the wastewater treatment process, where 1 represents the flow meter, 2 represents a dissolved oxygen detector, 3 represents a nitrate nitrogen detector, 4 represents an ammonia nitrogen detector, 5 represents a suspended solids concentration detector, 6 refers to effluent biochemical oxygen demand detector, 7 refers to the chemical oxygen demand detector of effluent, 8 represents the effluent ammonia nitrogen detector, 9 represents the total nitrogen detector for effluent, 10 represents the concentration of suspended solids in the effluent, 11 represents the pumping energy consumption power meter, 12 represents the aeration energy consumption power meter.

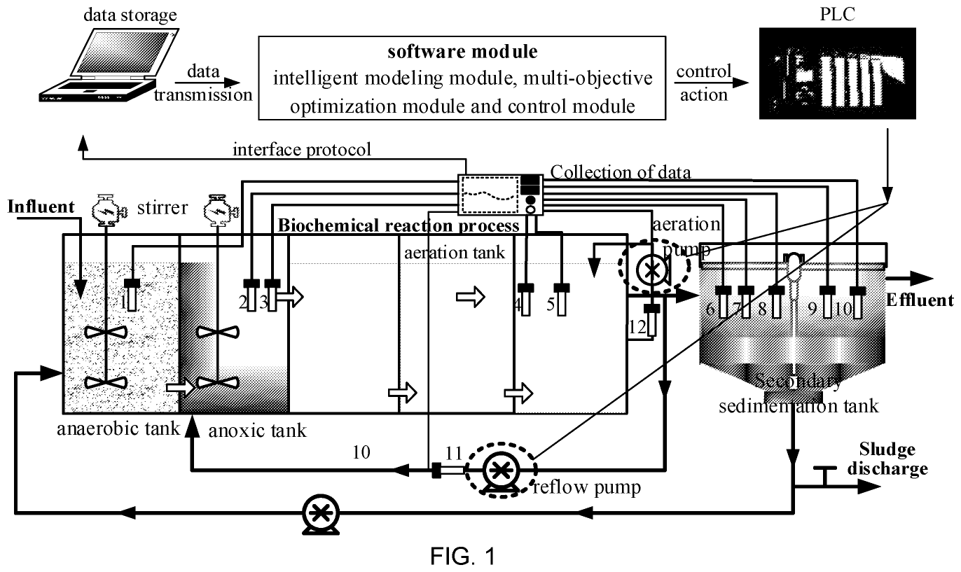

FIG. 2 shows the results of S_{O} in DMOPSO-based method.

FIG. 3 shows the results of S_{NO} in DMOPSO-based method.

### DETAILED DESCRIPTION

In this present invention, a dynamic multi-objective particle swarm optimization-based optimal control method and system for wastewater treatment process is designed, where hardware facilities and software modules are included.

The hardware facilities include data acquisition devices (flow meter, dissolved oxygen detector, nitrate nitrogen detector, ammonia nitrogen detector, suspended solids concentration detector, effluent biochemical oxygen demand detector, effluent chemical oxygen demand detector, effluent ammonia nitrogen detector, effluent total nitrogen detector, effluent suspended solids concentration), control devices (aeration pump, reflow pump), data transmission devices (communication interface, remote interface) and programmable logic controller PLC.

As the controlled object, WWTP mainly includes biochemical reaction process and sedimentation process, among them, the biochemical reaction process is divided into five tanks, including an anaerobic tank, an anoxic tank and three aerobic tanks, mainly involving three reaction processes. Firstly, wastewater enters an anaerobic tank from a water inlet for reaction of ammonization. Secondly, the wastewater enters an anoxic tank from the anaerobic tank for denitrification reaction. Finally, the wastewater flows from the anoxic tank to the three aerobic tanks for nitrification reaction, and flows into the secondary sedimentation tank for sedimentation. The anaerobic tank and the anoxic tank are respectively provided with a stirrer to fully mix the activated sludge and the wastewater. The aeration pump arranged at the third aerobic tank can charge oxygen for the three aerobic tanks, and the reflow pump arranged between the third aerobic tank and the anaerobic tank is used for controlling the reflow rate of the internal circulation. The treated wastewater enters a secondary sedimentation tank to realize the separation of activated sludge and effluent. Then the effluent is discharged from the upper end of the secondary sedimentation tank, part of the activated sludge is discharged from the bottom end of the secondary sedimentation tank, and the remaining sludge is returned to the anaerobic tank by the control action of the reflow pump arranged at the secondary sedimentation tank. Data acquisition sensors are arranged in the anaerobic tank, the anoxic tank, the aerobic tank and the secondary sedimentation tank.

The data acquisition device installed in the biochemical reaction process comprises:

A flow meter arranged in the anaerobic tank and used for acquiring inflow flow data, a portable dissolved oxygen detector installed in the third aerobic tank for obtaining dissolved oxygen concentration data, a nitrate nitrogen detector arranged in the anoxic tank and used for acquiring nitrate nitrogen concentration data, an ammonia nitrogen detector arranged in the third aerobic tank and used for acquiring ammonia nitrogen data, a suspended matter concentration detector installed in the anoxic tank for acquiring suspended matter concentration data.

The data acquisition device installed in the secondary sedimentation tank:

An effluent ammonia nitrogen detector for acquiring effluent ammonia nitrogen data, an effluent total nitrogen detector for acquiring effluent total nitrogen data, an effluent suspended matter concentration detector for acquiring effluent suspended matter data, an effluent biochemical oxygen demand detector for obtaining effluent biochemical oxygen demand data, a water outlet chemical oxygen demand detector used for acquiring water outlet chemical oxygen demand data.

The data transmission end of each instrument in the wastewater treatment process is connected to the computer by using the communication interface and the remote interface in the data transmission device. The programmable logic controller PLC is used for changing the rotating speed of the driving motor of the aeration pump and the reflow pump to control the output of the aeration pump and the reflow pump.

The software module includes data acquisition module, intelligent modeling module, multi-objective optimization module and control module.

The data acquisition module is used for acquiring data information such as process variables related to the wastewater treatment process and optimized operation performance indexes.

The intelligent modeling module is used for establishing an optimal operation performance index model of the wastewater treatment process, and comprises a pumping energy consumption model, an aeration energy consumption model and an effluent quality model.

The multi-objective optimization module is used for simultaneously optimizing a plurality of performance indexes of the wastewater treatment process, including pumping energy, aeration energy and effluent water quality, and obtaining optimal values of related control variables.

The control module compares the control action of the aeration pump and the reflow pump with the obtained optimized set value of the control variable, so as to carry out the control action.

The invention relates to a dynamic multi-objective particle swarm optimization-based optimal control method for WWTP, which comprises the following steps:

Step 1: acquiring each performance index parameters of WWTP through data acquisition sensors, and transmitting the performance index values and the related process variable values thereof to a data acquisition module. The performance indexes mainly include pumping energy (PE), aeration energy (AE) and effluent quality (EQ).

PE mainly refers to the power consumption generated by the internal reflow pump, which is measured by the pumping energy power meter. AE mainly refers to the power consumption generated by aeration pump during aeration, which is measured by aeration energy power meter. EQ mainly refers to the tax or penalty to be paid for discharging pollution to the receiving water body. The pollutants mainly include effluent ammonia nitrogen (S_{NH,e}), effluent total nitrogen (N_{tot,e}), effluent suspended solids (SSₑ), effluent biochemical oxygen demand (BODₑ), effluent chemical oxygen demand (CODₑ) obtained by the data acquisition devices installed in the secondary sedimentation tank.

Step 2: transmit the performance index values and the related process variable values thereof to an intelligent modeling module through a data transmission protocol, and the intelligent modeling module establish a performance index model of the wastewater treatment system according to the related process variables of the performance index obtained by the data acquisition module.

The wastewater treatment system performance index model comprises PE model, AE model and EQ model. With the progress of wastewater treatment operation, the collected data is also constantly updated, and performance index models in the intelligent modeling module will be updated and adjusted along with the change of the collected data. The steps for constructing a performance indicator model for sewage treatment process include:

\textcircled{1} obtain the operating data of the performance indices and the related process variables. The performance indices mainly contain PE, AE and EQ. The related process variables of PE, AE and EQ contain influent flow rate (Qᵢₙ), dissolved oxygen (S_{O}), nitrate nitrogen (S_{NO}), ammonia nitrogen (S_{NH}), suspended solids (SS), which can be measured by the corresponding sensors.

\textcircled{2} establish the nonlinear models of PE, AE, EQ and the related process variables. Since the adjusting time of the two controlled variables S_{O} and S_{NO} are different, the established models of PE, AE and EQ also have different adjusting periods. Because S_{O} has great influence on AE and EQ, the nonlinear models of AE and EQ will be adjusted every thirty minutes, which is the same as the adjusting period of S_{O}. In addition, S_{NO} has great influence on PE, so the model of PE will be adjusted every two hours, which is the same as the adjusting period of S_{NO}. Two sets of objectives are established

$$\begin{matrix}\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t )\end{matrix} & ( 1 ) \\ \{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t ) \\ {f}_{3} ( t ) = {\sum }_{r = 1}^{10} {W}_{3 r} ( t ) \times {e}^{- {‖ s ( t ) - {c}_{3 r} ( t ) ‖}^{2} / 2 {{b}_{3 r} ( t )}^{2}} + {W}_{3} ( t )\end{matrix} & ( 2 )\end{matrix}$$

where f₁(t) is AE model at the tth time, f₂(t) is EQ model at the tth time, f₃(t) is PE model at the tth time, x(t)=[Qᵢₙ(t), S_{O}(t)] is the inputs of AE model, l(t)=[Qᵢₙ(t), S_{O}(t), S_{NO}(t), S_{NH}(t), SS(t)] is the inputs of EQ model, s(t)=[Qᵢₙ(t), S_{NO}(t), SS(t)] is the inputs of PE model,

$${e}^{- {‖ x ( t ) - {c}_{1 r} ( t ) ‖}^{2} / 2 {{b}_{1 r} ( t )}^{2}} , {e}^{- {‖ l ( t ) - {c}_{2 r} ( t ) ‖}^{2} / 2 {{b}_{2 r} ( t )}^{2}} and {e}^{- {‖ s ( t ) - {c}_{3 r} ( t ) ‖}^{2} / 2 {{b}_{3 r} ( t )}^{2}}$$

are the rth radial basis functions of f₁(t), f₂(t) and f₃(t) at the tth time, r=1, 2, . . . , 10, c₁ᵣ(t), c₂ᵣ(t) and c₃ᵣ(t) are the center vectors of the rth radial basis functions of f₁(t), f₂(t) and f₃(t) at the tth time, and the ranges of c₁ᵣ(t), c₂ᵣ(t) and c₃ᵣ(t) are [−1, 1] respectively; b₁ᵣ(t), b₂ᵣ(t) and b₃ᵣ(t) are the width vectors of the rth radial basis functions of f₁(t), f₂(t) and f₃(t) at the tth time, whose ranges are (0, 2] respectively, W₁ᵣ(t), W₂ᵣ(t) and W₃ᵣ(t) are the weight vectors of the rth radial basis functions of f₁(t) and f₂(t) at the tth time, whose ranges are [−3, 3] respectively; W₁(t), W₂(t) and W₃(t) are the biases of the rth radial basis functions of f₁(t) and f₂(t) at the tth time, whose ranges are [−2, 2] respectively. When every two hours is reached, Eq. (2) is taken as the operating objectives, otherwise, Eq. (1) is regarded as the operating objectives.

Step 3: transmitting model results of the PE model, AE model and EQ model built in the intelligent modeling module to the multi-objective optimization module. In the multi-objective optimization module, the constructed PE model, AE model and EQ model are taken as optimization objectives, and then the optimization objectives are optimized by using the designed dynamic multi-objective particle swarm optimization algorithm to obtain the optimized set values of the control variables S_{O} and S_{NO}.

Since the optimal set values of S_{O} and S_{NO} change in real time with the progress of wastewater treatment operation process, the optimal set values of S_{O} and S_{NO} concentration are recalculated every two hours. The updated optimized set points for dissolved oxygen and nitrate concentration are transmitted to the control module in real time.

In WWTP, S_{O} and S_{NO} are two important controlled variables to guarantee the treatment results and improve the operating performance. Due to the changes of passively accepted influent flow rate, fixed set-points of S_{O} and S_{NO} are not beneficial for reducing the PE, AE and EQ. Therefore, a dynamic optimization algorithm is designed for calculating the time-varying set-points of S_{O} and S_{NO}. The steps of the dynamic optimization process include:

(3)-1 set the maximum iterative numbers of the optimization process Tₘₐₓ, Tₘₐₓ=200;

(3)-2 take the established models of performance indices in Eq. (1) and (2) as the optimization objectives;

(3)-3 regard all the related inputs of PE, AE and EQ as the position of the particles, a(t)=[Qᵢₙ(t), S_{O}(t), S_{NO}(t), S_{NH}(t), SS(t)], calculate values of the optimization objectives, update the personal optimal position (pBest_{k,i}(t)) and the position and the velocity of the particles, the update process are:

a_{k,i}(t+1)=a_{k,i}(t)+v_{k,i}(t+1) (3)

v_{k,i}(t+1)=ω(t)v_{k,i}(t)+c₁α₁(pBest_{k,i}(t)−x_{k,i}(t))+c₂α₂(gBestₖ(t)−(t)) (4)

where a_{k,i}(t+1) is the position of the ith particle in the kth iteration at the t+1th time, v_{k,i}(t+1) is the velocity of the ith particle in the kth iteration at the t+1th time, ω is the inertia weight, ω=0.8, c₁ and c₂ are the learning parameters, c₁=0.4, c₂=0.4, α₁ and α₂ are the uniformly distributed random numbers, α₁=0.2, α₂=0.2, pBest_{k,i}(t) is the personal optimal position of the ith particle in the kth iteration at the tth time, and gBestₖ(t) is the personal optimal position in the kth iteration at the tth time;

(3)-4 design the diversity index and the convergence index based on the Chebyshev distance, diversity index is designed to measure the distribution quality of the non-dominated solutions,

$$U ( t ) = \sqrt{\frac{1}{NS ( t ) - 1} {\sum }_{m = 1}^{NS ( t )} {( {D}^{⌣} ( t ) - {D}_{m} ( t ) )}^{2}} \qquad ( 5 )$$

where U(t) is the diversity of the optimal solutions at the tth time, m=1, 2, . . . , NS(t), NS(t) is the number of non-dominated solutions at time t, \textcircled{D}(t) is the average distance of all the Chebyshev distance Dₘ(t), Dₘ(t) is the Chebyshev distance of consecutive solutions of the mth solution; and convergence index is developed to obtain the degree of proximity, which are calculated as

$$A ( t ) = \frac{1}{NS ( t )} \sqrt{{\sum }_{l = 1}^{NS ( t )} {d}_{l} ( t )} \qquad ( 6 )$$

where A(t) is the convergence of the optimal solutions at the tth time, dₗ(t) is the Chebyshev distance of the lth solution between the kth iteration and the k−1th iteration;

(3)-5 judge the changes of the optimization objectives, if the number of the objectives is changed, return to step (3)-6; otherwise, return to (3)-7;

(3)-6 when the number of the objectives is increased, some particles will be changed to enhance the diversity performance, the update process of the population size is

$${N}_{k + 1} ( t ) = \{ \begin{matrix}{N}_{k} ( t ) & {α}_{k} = 0 \\ {N}_{k} ( t ) - ( {N}_{k} ( t ) - {NS}_{k} ( t ) ) \cdot {α}_{k} ( t ) & {α}_{k} < 0 \\ {N}_{k} ( t ) + {NS}_{k} ( t ) \cdot {α}_{k} ( t ) & {α}_{k} > 0\end{matrix} \qquad ( 7 )$$

where Nₖ₊₁(t) and Nₖ(t) are the population size in the kth iteration and in the k+1th iteration at the tth time respectively, aₖ(t) is the gradient of diversity in the kth iteration at the tth time, which is calculated as

$${α}_{k} ( t ) = \frac{{U}_{k} ( t ) - {U}_{k} ( t - ε )}{ε} \qquad ( 8 )$$

where ε is the adjusted frequency of population size, and the range of ε is [1, 200]; if the number of the objectives is decreased, some particles will be changed to improve the convergence performance, the update process of the population size is

$${N}_{k + 1} ( t ) = \{ \begin{matrix}{N}_{k} ( t ) & {β}_{k} ( t ) = 0 \\ {N}_{k} ( t ) + {NS}_{k} ( t ) \cdot {β}_{k} ( t ) & {β}_{k} ( t ) < 0 \\ {N}_{k} ( t ) - ( {N}_{k} ( t ) - {NS}_{k} ( t ) ) \cdot {β}_{k} ( t ) & {β}_{k} ( t ) > 0\end{matrix} \qquad ( 9 )$$

where βₖ(t) is the gradient of convergence in the kth iteration at the tth time, which is calculated as

$${β}_{k} ( t ) = \frac{{A}_{k} ( t ) - {A}_{k} ( t - ε )}{ε} \qquad ( 10 )$$

(3)-7 compare pBestₖ(t) with the solutions Φₖ₋₁(t) in the archive, where Φₖ₋₁(t)=[φ_{k-1,1}(t), φ_{k-1,2}(t), . . . , φ_{k-i,l}(t)], φ_{k-1,i}(t) is the lth optimal solutions in the k−1th iteration at the tth time of the archive, the archive Φₖ(t) is updated by the dominated relationship, and the calculation process of the dominated relationship can be shown as

Φₖ(t)=Φₖ₋₁(t)∪pₖ₋₁(t), if fₕ(aₖ₋₁(t))≥fₕ(pₖ(t)), h=1,2,3 (11)

where ∪ is the relationship of combine, if the value of pBestₖ₋₁(t) is lower than the objective value of a_{k-1,l}(t), then the pBestₖ₋₁(t) will be saved in the archive, otherwise, a_{k-1,l}(t) will be saved, then gBestₖ(t) will be selected from the archive according to the density method;

(3)-8 if the current iteration is greater than the preset Tₘₐₓ, then return to step (3)-9, otherwise, return to step (3)-3;

(3)-9 select a set of global optimal solutions gBest_{Tmax}(t) from the archive randomly, and gBest_{Tmax}(t)=[Q_{in,Tmax}*(t), S_{O,Tmax}*(t) S_{NO,Tmax}*(t), S_{NH,Tmax}*(t) SS_{Tmax}*(t)], where Q_{in,Tmax}*(t) is the optimal solution of influent flow rate, S_{O,Tmax}*(t) is the optimal solution of dissolved oxygen, S_{NO,Tmax}*(t) is the optimal solution of nitrate nitrogen, S_{NH,Tmax}*(t) is the optimal solution of ammonia nitrogen, SS_{Tmax}*(t) is the optimal solution of suspend solid.

Step 4: transmitting the optimized set values of S_{O,Tmax}* and S_{NO,Tmax}* obtained in step 3 to a control module, changing the rotating speeds of the driving motors of the aeration pump and the reflow pump by adjusting the variable quantity of the variable frequency output of the programmable logic controller PLC, controlling the air velocity of the aeration pump and the internal circulation flow of the reflow pump, thereby controlling the concentration of S_{O} in the third aerobic tank and the concentration of S_{NO} in the anoxic tank. The control action is obtained by a multivariable PID controller, which can be shown as

$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$

where Δu(t)=[ΔKLa(t), ΔQₐ(t)]^{T}, ΔK_{L}a(t) is the variation of oxygen transfer coefficient in the third aeration tank at time t, ΔQₐ(t) is the variation of internal recycle flow rate at time t, Kₚ is the proportionality coefficient, H_{τ} is the integral time constants, H_{d} is the differential time constants, e(t) is the error between the real output and the optimal solution

e(t)=z(t)−y(t) (13)

where e(t)=[e₁(t), e₂(t)]^{T}, e₁(t) and e₂(t) are the errors of S_{O} and S_{NO}, respectively; z(t)=[z₁(t), z₂(t)]^{T}, z₁(t) and z₂(t) are the derived optimal set-points of S_{O} and S_{NO} at time t, y(t)=[y₁(t), y₂(t)]^{T}, y₁(t) and y₂(t) are the real values of S_{O} and S_{NO} at time t.

As the optimal set-points of S_{O,Tmax}* and S_{NO,Tmax}* are changing timely, it is necessary to compare the control action of airflow rate and internal recycle flow rate with the response of S_{O} and S_{NO} concentration.

When the real concentration value of S_{O} is close to the optimized set value of the S_{O} concentration obtained in the step 3, the control quantity of the current frequency conversion output of the PLC is kept, and the rotating speed of the driving motor of the aeration pump is not changed. When the real value of S_{O} is less than the optimized set value, the variation of the current frequency conversion output of the PLC is calculated according to the control method in the control module, the rotating speed of the driving motor of the aeration pump is increased, and the aeration amount of the aeration pump is increased, so that the microbial activity is increased and the effluent quality is improved. When the real value of S_{O} is greater than the optimized set value, the variation of the current frequency conversion output of the PLC is calculated by a control method in the control module, the rotating speed of the driving motor of the aeration pump is reduced, and the aeration amount of the aeration pump is reduced, so that the aeration energy consumption is reduced.

When the real concentration value of the nitrate nitrogen is close to the optimized set value of the nitrate nitrogen concentration obtained in the step 3, the control quantity of the current variable frequency output of the PLC is kept, and the rotating speed of the driving motor of the reflow pump is not changed. When the real value of nitrate nitrogen is less than the optimized set value, the variation of the current frequency conversion output of the PLC is calculated according to the variation of the internal circulation flow, the rotating speed of the driving motor of the reflow pump is increased, and the reflow rate of the reflow pump is increased, so that the nitrogen is removed and the effluent quality is improved. When the real value of nitrate nitrogen is greater than the optimized set value, the change amount of the current variable frequency output of the PLC is calculate according to the change of the internal circulation flow, the rotating speed of the driving motor of the reflow pump is reduced, and the reflow rate of the reflow pump is reduced, so that the pumping energy consumption is reduced.

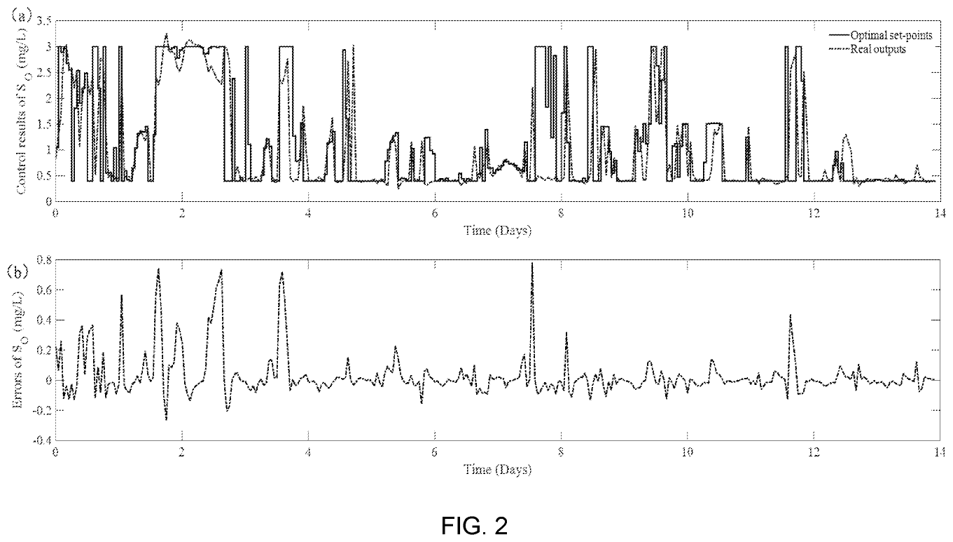

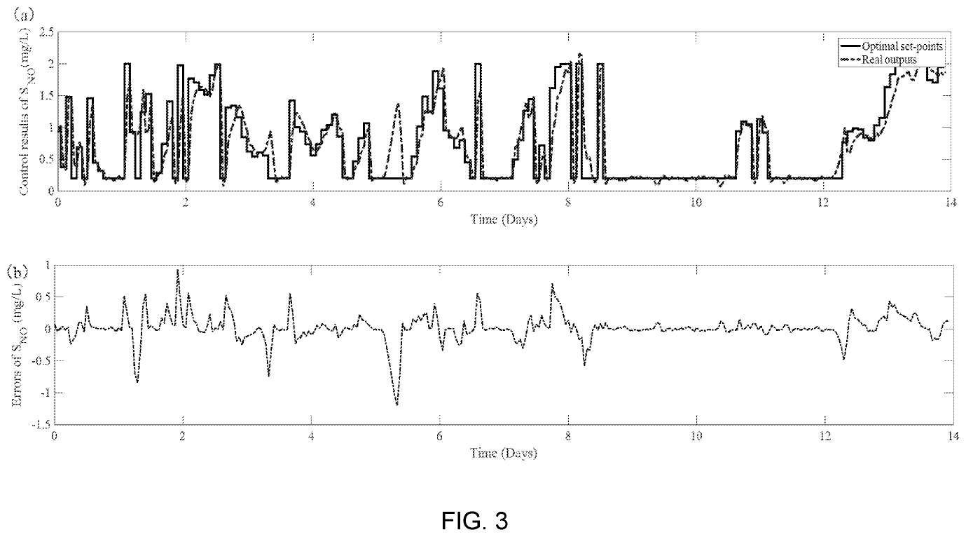

The outputs of the designed DMOPSO-based optimal control method is the concentration of S_{O} and S_{NO}. FIG. 2(a) gives S_{O} values, X axis shows the time, and the unit is day, Y axis is control results of S_{O}, and the unit is mg/L. FIG. 2(b) gives the control errors of S_{O}, X axis shows the time, and the unit is day, Y axis is control errors of S_{O}, and the unit is mg/L. FIG. 3(a) gives the S_{NO} values, X axis shows the time, and the unit is day, Y axis is control results of S_{NO}, and the unit is mg/L. FIG. 3(b) gives the control errors of S_{NO}, X axis shows the time, and the unit is day, Y axis is control errors of S_{NO}, and the unit is mg/L.

What is claimed is:

1. A dynamic multi-objective particle swarm optimization-based optimal control method of a system for wastewater treatment process (WWTP), wherein the system comprises:
data acquisition devices, including flow meter, dissolved oxygen detector, nitrate nitrogen detector, ammonia nitrogen detector, suspended solids concentration detector, effluent biochemical oxygen demand detector, effluent chemical oxygen demand detector, effluent ammonia nitrogen detector, effluent total nitrogen detector, effluent suspended solids concentration;
control devices, including aeration pump, reflow pump;
data transmission devices, including communication interface, remote interface; and
a programmable logic controller PLC.
the WWTP mainly includes biochemical reaction process and sedimentation process, among them, the biochemical reaction process is divided into five tanks, including an anaerobic tank, an anoxic tank and three aerobic tanks, mainly involving three reaction processes; firstly, wastewater enters an anaerobic tank from a water inlet for reaction of ammonization, secondly, the wastewater enters an anoxic tank from the anaerobic tank for denitrification reaction, finally, the wastewater flows from the anoxic tank to the three aerobic tanks for nitrification reaction, and flows into the secondary sedimentation tank for sedimentation; the anaerobic tank and the anoxic tank are respectively provided with a stirrer to fully mix the activated sludge and the wastewater; the aeration pump arranged at the third aerobic tank can charge oxygen for the three aerobic tanks, and the reflow pump arranged between the third aerobic tank and the anaerobic tank is used for controlling the reflow rate of the internal circulation; the treated wastewater enters a secondary sedimentation tank to realize the separation of activated sludge and effluent; then the effluent is discharged from the upper end of the secondary sedimentation tank, part of the activated sludge is discharged from the bottom end of the secondary sedimentation tank, and the remaining sludge is returned to the anaerobic tank by the control action of the reflow pump arranged at the secondary sedimentation tank; data acquisition sensors are arranged in the anaerobic tank, the anoxic tank, the aerobic tank and the secondary sedimentation tank;
the data acquisition device installed in the biochemical reaction process comprises:
a flow meter arranged in the anaerobic tank and used for acquiring inflow flow data, a portable dissolved oxygen detector installed in the third aerobic tank for obtaining dissolved oxygen concentration data, a nitrate nitrogen detector arranged in the anoxic tank and used for acquiring nitrate nitrogen concentration data, an ammonia nitrogen detector arranged in the third aerobic tank and used for acquiring ammonia nitrogen data, a suspended matter concentration detector installed in the anoxic tank for acquiring suspended matter concentration data;
the data acquisition device installed in the secondary sedimentation tank:
an effluent ammonia nitrogen detector for acquiring effluent ammonia nitrogen data, an effluent total nitrogen detector for acquiring effluent total nitrogen data, an effluent suspended matter concentration detector for acquiring effluent suspended matter data, an effluent biochemical oxygen demand detector for obtaining effluent biochemical oxygen demand data, a water outlet chemical oxygen demand detector used for acquiring water outlet chemical oxygen demand data;
the data transmission end of each instrument in the wastewater treatment process is connected to the computer by using the communication interface and the remote interface in the data transmission device; the programmable logic controller PLC is used for changing the rotating speed of the driving motor of the aeration pump and the reflow pump to control the output of the aeration pump and the reflow pump;
the software module includes data acquisition module, intelligent modeling module, multi-objective optimization module and control module;
the data acquisition module is used for acquiring data information such as process variables related to the wastewater treatment process and optimized operation performance indexes;
the intelligent modeling module is used for establishing an optimal operation performance index model of the wastewater treatment process, and comprises a pumping energy consumption model, an aeration energy consumption model and an effluent quality model;
the multi-objective optimization module is used for simultaneously optimizing a plurality of performance indexes of the wastewater treatment process, including pumping energy, aeration energy and effluent water quality, and obtaining optimal values of related control variables;
the control module compares the control action of the aeration pump and the reflow pump with the obtained optimized set value of the control variable, so as to carry out the control action;
the dynamic multi-objective particle swarm optimization-based optimal control method for WWTP comprises the following steps:
Step 1: acquiring each performance index parameters of WWTP through data acquisition sensors, and transmitting the performance index values and the related process variable values thereof to a data acquisition module, the performance indexes mainly include pumping energy (PE), aeration energy (AE) and effluent quality (EQ);
PE mainly refers to the power consumption generated by the internal reflow pump, which is measured by the pumping energy power meter. AE mainly refers to the power consumption generated by aeration pump during aeration, which is measured by aeration energy power meter. EQ mainly refers to the tax or penalty to be paid for discharging pollution to the receiving water body; the pollutants mainly include effluent ammonia nitrogen (S_{NH,e}), effluent total nitrogen (N_{tot,e}), effluent suspended solids (SSₑ), effluent biochemical oxygen demand (BODₑ), effluent chemical oxygen demand (CODₑ) Obtained by the data acquisition devices installed in the secondary sedimentation tank;
Step 2: transmit the performance index values and the related process variable values thereof to an intelligent modeling module through a data transmission protocol, and the intelligent modeling module establish a performance index model of the wastewater treatment system according to the related process variables of the performance index obtained by the data acquisition module;
the wastewater treatment system performance index model comprises PE model, AE model and EQ model, with the progress of wastewater treatment operation, the collected data is also constantly updated, and performance index models in the intelligent modeling module will be updated and adjusted along with the change of the collected data;
the steps for constructing a performance indicator model for sewage treatment process include:
\textcircled{1} obtain the operating data of the performance indices and the related process variables, the performance indices mainly contain PE, AE and EQ, the related process variables of PE, AE and EQ contain influent flow rate (Qᵢₙ), dissolved oxygen (S_{O}), nitrate nitrogen (S_{NO}), ammonia nitrogen (S_{NH}), suspended solids (SS), which can be measured by the corresponding sensors;
\textcircled{2} establish the nonlinear models of PE, AE, EQ and the related process variables; since the adjusting time of the two controlled variables S_{O} and S_{NO} are different, the established models of PE, AE and EQ also have different adjusting periods; because S_{O} has great influence on AE and EQ, the nonlinear models of AE and EQ will be adjusted every thirty minutes, which is the same as the adjusting period of S_{O}; in addition, S_{NO} has great influence on PE, so the model of PE will be adjusted every two hours, which is the same as the adjusting period of S_{NO}; two sets of objectives are established:
$$\begin{matrix}\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t )\end{matrix} & ( 1 ) \\ \{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ l ( t ) - {c}_{2 r} ( t ) ‖}^{2} / 2 {{b}_{2 r} ( t )}^{2}} + {W}_{2} ( t ) \\ {f}_{3} ( t ) = {\sum }_{r = 1}^{10} {W}_{3 r} ( t ) \times {e}^{- {‖ s ( t ) - {c}_{2 r} ( t ) ‖}^{2} / 2 {{b}_{3 r} ( t )}^{2}} + {W}_{3} ( t )\end{matrix} & ( 2 )\end{matrix}$$
Where f₁(t) is AE model at the tth time, f₂(t) is EQ model at the tth time, f₃(t) is PE model at the tth time, x(t)=[Qᵢₙ(t), S_{O}(t)] is the inputs of AE model, l(t)=[Qᵢₙ(t), S_{O}(t), S_{NO}(t), S_{NH}(t), SS(t)] is the inputs of EQ model, s(t)=[Qᵢₙ(t), S_{NO}(t), SS(t)] is the inputs of PE model,
$${e}^{- {‖ x ( t ) - {c}_{1 r} ( t ) ‖}^{2} / 2 {{b}_{1 r} ( t )}^{2}} , {e}^{- {‖ l ( t ) - {c}_{2 r} ( t ) ‖}^{2} / 2 {{b}_{2 r} ( t )}^{2}} and {e}^{- {‖ s ( t ) - {c}_{2 r} ( t ) ‖}^{2} / 2 {{b}_{3 r} ( t )}^{2}}$$
are the rth radial basis functions of f₁(t), f₂(t) and f₃(t) at the tth time, r=1, 2, . . . , 10, c₁ᵣ(t), c₂ᵣ(t) and c₃ᵣ(t) are the center vectors of the rth radial basis functions of f₁(t), f₂(t) and f₃(t) at the tth time, and the ranges of c₁ᵣ(t), c₂ᵣ(t) and c₃ᵣ(t) are [−1, 1] respectively; b₁ᵣ(t), b₂ᵣ(t) and b₃ᵣ(t) are the width vectors of the rth radial basis functions of f₁(t), f₂(t) and f₃(t) at the tth time, whose ranges are (0, 2) respectively, W₁ᵣ(t), W₂ᵣ(t) and W₃ᵣ(t) are the weight vectors of the rth radial basis functions of f₁(t) and f₂(t) at the tth time, whose ranges are [−3, 3] respectively; W₁(t), W₂(t) and W₃(t) are the biases of the rth radial basis functions of f₁(t) and f₂(t) at the tth time, whose ranges are [−2, 2] respectively; when every two hours is reached, Eq. (2) is taken as the operating objectives, otherwise, Eq. (1) is regarded as the operating objectives;
Step 3: transmitting model results of the PE model, AE model and EQ model built in the intelligent modeling module to the multi-objective optimization module; in the multi-objective optimization module, the constructed PE model, AE model and EQ model are taken as optimization objectives, and then the optimization objectives are optimized by using the designed dynamic multi-objective particle swarm optimization algorithm to obtain the optimized set values of the control variables S_{O} and S_{NO};
since the optimal set values of S_{O} and S_{NO} change in real time with the progress of wastewater treatment operation process, the optimal set values of S_{O} and S_{NO} concentration are recalculated every two hours; the updated optimized set points for dissolved oxygen and nitrate concentration are transmitted to the control module in real time;
in WWTP, S_{O} and S_{NO} are two important controlled variables to guarantee the treatment results and improve the operating performance; due to the changes of passively accepted influent flow rate, fixed set-points of S_{O} and S_{NO} are not beneficial for reducing the PE, AE and EQ. Therefore, a dynamic optimization algorithm is designed for calculating the time-varying set-points of S_{O} and S_{NO}; the steps of the dynamic optimization process include:
(3)-1 set the maximum iterative numbers of the optimization process Tₘₐₓ;
(3)-2 take the established models of performance indices in Eq. (1) and (2) as the optimization objectives;
(3)-3 regard all the related inputs of PE, AE and EQ as the position of the particles, a(t)=[Qᵢₙ(t), S_{O}(t), S_{NO}(t), S_{NH}(t), SS(t)], calculate values of the optimization objectives, update the personal optimal position (pBest_{k,i}(t)) and the position and the velocity of the particles, the update process are:
a_{k,i}(t+1)=a_{k,i}(t)+v_{k,i}(t+1) (3)
v_{k,i}(t+1)=ω(t)v_{k,i}(t)+c₁α₁(pBest_{k,i}(t)−x_{k,i}(t))+c₂α₂(gBestₖ(t)−x_{k,i}(t)) (4)
where a_{k,i}(t+1) is the position of the ith particle in the kth iteration at the t+1th time, v_{k,i}(t+1) is the velocity of the ith particle in the kth iteration at the t+1th time, ω is the inertia weight, the range of ω is (0, 1], c₁ and c₂ are the learning parameters, α₁ and α₂ are the uniformly distributed random numbers, pBest_{k,i}(t) is the personal optimal position of the ith particle in the kth iteration at the tth time, and gBestₖ(t) is the personal optimal position in the kth iteration at the tth time;
(3)-4 design the diversity index and the convergence index based on the Chebyshev distance, diversity index is designed to measure the distribution quality of the non-dominated solutions,
$$U ( t ) = \sqrt{\frac{1}{NS ( t ) - 1} {\sum }_{m = 1}^{NS ( t )} {( {D}^{⌣} ( t ) - {D}_{m} ( t ) )}^{2}} \qquad ( 5 )$$
where U(t) is the diversity of the optimal solutions at the tth time, m=1, 2, . . . , NS(t), NS(t) is the number of non-dominated solutions at time t, Ď(t) is the average distance of all the Chebyshev distance Dₘ(t), Dₘ(t) is the Chebyshev distance of consecutive solutions of the mth solution; and convergence index is developed to obtain the degree of proximity, which are calculated as
$$A ( t ) = \frac{1}{NS ( t )} \sqrt{{\sum }_{l = 1}^{NS ( t )} {d}_{l} ( t )} \qquad ( 6 )$$
where A(t) is the convergence of the optimal solutions at the tth time, dₗ(t) is the Chebyshev distance of the lth solution between the kth iteration and the k−1th iteration;
(3)-5 judge the changes of the optimization objectives, if the number of the objectives is changed, return to step (3)-6; otherwise, return to (3)-7;
(3)-6 when the number of the objectives is increased, some particles will be changed to enhance the diversity performance, the update process of the population size is
$${N}_{k + 1} ( t ) = \{ \begin{matrix}{N}_{k} ( t ) & {α}_{k} = 0 \\ {N}_{k} ( t ) - ( {N}_{k} ( t ) - {NS}_{k} ( t ) ) \cdot {α}_{k} ( t ) & {α}_{k} < 0 \\ {N}_{k} ( t ) + {NS}_{k} ( t ) \cdot {α}_{k} ( t ) & {α}_{k} > 0\end{matrix} \qquad ( 7 )$$
where Nₖ₊₁(t) and Nₖ(t) are the population size in the kth iteration and in the k+1th iteration at the tth time respectively, αₖ(t) is the gradient of diversity in the kth iteration at the tth time, which is calculated as
$${α}_{k} ( t ) = \frac{{U}_{k} ( t ) - {U}_{k} ( t - ε )}{ε} \qquad ( 8 )$$
where ε is the adjusted frequency of population size, and the range of ε is [1, Tₘₐₓ]; if the number of the objectives is decreased, some particles will be changed to improve the convergence performance, the update process of the population size is
$${N}_{k + 1} ( t ) = \{ \begin{matrix}{N}_{k} ( t ) & {β}_{k} ( t ) = 0 \\ {N}_{k} ( t ) + {NS}_{k} ( t ) \cdot {β}_{k} ( t ) & {β}_{k} ( t ) < 0 \\ {N}_{k} ( t ) - ( {N}_{k} ( t ) - {NS}_{k} ( t ) ) \cdot {β}_{k} ( t ) & {β}_{k} ( t ) > 0\end{matrix} \qquad ( 9 )$$
where, βₖ(t) is the gradient of convergence in the kth iteration at the tth time, which is calculated as
$${β}_{k} ( t ) = \frac{{A}_{k} ( t ) - {A}_{k} ( t - ε )}{ε} \qquad ( 10 )$$
(3)-7 compare pBestₖ(t) with the solutions Φₖ₋₁₍t) in the archive, where Φₖ₋₁(t)=[φ_{k-1,1}(t), φ_{k-1,2}(t), . . . , φ_{k-1,i}(t)], φ_{k-1,i}(t) is the tth optimal solutions in the k−1th iteration at the tth time of the archive, the archive Φₖ(t) is updated by the dominated relationship, and the calculation process of the dominated relationship can be shown as
Φₖ(t)=Φₖ₋₁(t)∪pₖ₋₁(t), if fₕ(aₖ₋₁(t))≥fₕ(pₖ(t)), h=1,2,3 (11)
where ∪ is the relationship of combine, if the value of pBestₖ₋₁(t) is lower than the objective value of a_{k-1,l}(t), then the pBestₖ₋ₗ(t) will be saved in the archive, otherwise, a_{k-1,l}(t) will be saved, then gBestₖ(t) will be selected from the archive according to the density method;
(3)-8 if the current iteration is greater than Tₘₐₓ, then return to step (3)-9, otherwise, return to step (3)-3;
(3)-9 select a set of global optimal solutions gBest_{Tmax}(t) from the archive randomly, and gBest_{Tmax}(t)=[Q_{in,Tmax}*(t), S_{O,Tmax}*(t), S_{NO,Tmax}*(t), S_{NH,Tmax}*(t), SS_{Tmax}*(t)], where Q_{in,Tmax}*(t) is the optimal solution of influent flow rate, S_{O,Tmax}*(t) is the optimal solution of dissolved oxygen, S_{NO,Tmax}*(t) is the optimal solution of nitrate nitrogen, S_{NH,Tmax}*(t) is the optimal solution of ammonia nitrogen, SS_{Tmax}*(t) is the optimal solution of suspend solid;
Step 4: transmitting the optimized set values of S_{O,Tmax}* and S_{NO,Tmax}* obtained in step 3 to a control module, changing the rotating speeds of the driving motors of the aeration pump and the reflow pump by adjusting the variable quantity of the variable frequency output of the programmable logic controller PLC, controlling the air velocity of the aeration pump and the internal circulation flow of the reflow pump, thereby controlling the concentration of S_{O} in the third aerobic tank and the concentration of S_{NO} in the anoxic tank. The control action is obtained by a multivariable PID controller, which can be shown as
$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$
where Δu(t)=[ΔK_{L}a(t), ΔQₐ(t)]^{T}, ΔK_{L}a(t) is the variation of oxygen transfer coefficient in the third aeration tank at time t, ΔQₐ(t) is the variation of internal recycle flow rate at time t, Kₚ is the proportionality coefficient, H_{τ} is the integral time constants, H_{d} is the differential time constants, e(t) is the errors between the real outputs and the optimal set-points
e(t)=z(t)−y(t) (13)
where e(t)=[e₁(t), e₂(t)]^{T}, e₁(t) and e₂(t) are the errors of S_{O} and S_{NO} respectively, z(t)=[z₁(t), z₂(t)]^{T}, z₁(t) and z₂(t) are the derived optimal set-points of S_{O} and S_{NO} at time t, y(t)=[y₁(t), y₂(t)]^{T}, y₁(t) and y₂(t) are the real values of S_{O} and S_{NO} at time t;
as the optimal set-points of S_{O,Tmax}* and S_{NO,Tmax}* are changing timely, it is necessary to compare the control action of airflow rate and internal recycle flow rate with the response of S_{O} and S_{NO} concentration;
when the real concentration value of S_{O} is close to the optimized set value of the S_{O} concentration obtained in the step 3, the control quantity of the current frequency conversion output of the PLC is kept, and the rotating speed of the driving motor of the aeration pump is not changed; when the real value of S_{O} is less than the optimized set value, the variation of the current frequency conversion output of the PLC is calculated according to the control method in the control module, the rotating speed of the driving motor of the aeration pump is increased, and the aeration amount of the aeration pump is increased, so that the microbial activity is increased and the effluent quality is improved; when the real value of S_{O} is greater than the optimized set value, the variation of the current frequency conversion output of the PLC is calculated by a control method in the control module, the rotating speed of the driving motor of the aeration pump is reduced, and the aeration amount of the aeration pump is reduced, so that the aeration energy consumption is reduced;
when the real concentration value of the nitrate nitrogen is close to the optimized set value of the nitrate nitrogen concentration obtained in the step 3, the control quantity of the current variable frequency output of the PLC is kept, and the rotating speed of the driving motor of the reflow pump is not changed; when the real value of nitrate nitrogen is less than the optimized set value, the variation of the current frequency conversion output of the PLC is calculated according to the variation of the internal circulation flow, the rotating speed of the driving motor of the reflow pump is increased, and the reflow rate of the reflow pump is increased, so that the nitrogen is removed and the effluent quality is improved; when the real value of nitrate nitrogen is greater than the optimized set value, the change amount of the current variable frequency output of the PLC is calculate according to the change of the internal circulation flow, the rotating speed of the driving motor of the reflow pump is reduced, and the reflow rate of the reflow pump is reduced, so that the pumping energy consumption is reduced.
